(19) United States
(12) Patent Application Publication
(10) Pub. No.: US 2009/0238737 A1
(43) Pub. Date: Sep. 24, 2009

(54) APPARATUS FOR STERILIZING AND SMOOTHING FINE SANDS

(76) Inventor: Toyofumi MIYAZAKI, Kato-shi (JP)

Correspondence Address: SMITH PATENT OFFICE, 1901 PENNSYLVANIA AVENUE N W, SUITE 901, WASHINGTON, DC, 20006, US

(21) Appl. No.: 12/426,636

(22) Filed: Apr. 20, 2009

(30) Foreign Application Priority Data
Aug. 29, 2007 (JP) PCT/JP2007/066748

(51) Int. Cl. B01J 19/10

(52) U.S. Cl. 422/291

(57) ABSTRACT

There is provided an apparatus for sterilizing and smoothing fine sands that can reliably sterilize sands through the dispersion of sands without increasing bulk thereof, and can make the shape of sand be optimum for water purification. The apparatus includes a feed chamber 13, burners 14, and receiving means 17. The feed chamber has a closed cross-sectional shape, includes an upstream receiving port 13D and a downstream discharge port 13E, receives fine sand through the upstream receiving port, feeds the fine sands to the downstream discharge port by applying forward feed vibration while making the fine sands bounce by applying vertical vibration, and makes the fine sands separated from raw material sands be rubbed against each other while vibrating the fine sands in vertical and back-and forth directions so that sharp portions of the fine sand become round. The burners heat, sterilize, and separate the fine sands by supplying hot air having high temperature to the raw material sands that is to be fed to or have been fed to the feed chamber. The receiving means receives the sterilized and rubbed fine sands, of which the sharp portions are removed, fed from the downstream discharge port of the feed chamber.

### BACKGROUND OF THE INVENTION

1. Field of the Invention

The present invention relates to an apparatus for sterilizing and smoothing fine sands, and more particularly, to an apparatus that sterilizes and polish ultra fine sands, which are used, for example, water purification, by heating the ultra fine sands and rubbing the surface of ultra fine sands each other.

2. Discussion of the Related Art

For example, a low speed filtrating method and a high speed filtrating method have been generally known as a method of producing drinking water from raw water. The low speed filtrating method is a method of purifying raw water by performing a microbial treatment with an ultra fine sand filter layer and filtrating foreign substances. The low speed filtrating method slowly performs a treatment as compared to the high speed filtrating method that performs a treatment by using chemicals such as chlorine, but is excellent for drinking water in terms of less chemical flavor (Japanese Patent Application Publication No. 07-308518 and Japanese Patent No. 3406258).

Specifications of the turbidity of water, which is purified by filter sands, are provided. It is required that turbidness is low and saprophytic bacteria or foreign substances such as organic impurities are as few as possible. Filter sands used for low speed filtration uses sea sands, river sands, and mountain sands as raw material sands. However, since foreign substances such as organic impurities and saprophytic bacteria are attached to the surfaces of grains of the raw material sands, the foreign substances or saprophytic bacteria need to be removed when the sands are used.

There have been known a method of sterilizing raw material sands, such as collected sea sands, river sands, and mountain sands by heating the raw material sands to high temperature in a kiln while the raw material sands are fed by a conveyor, such as a screw conveyor or a net conveyor (Japanese Patent Application Publication Nos. 10-234831 and 07-289613). There have been known a method of sterilizing raw material sands by supplying hot air to the raw material sands from below side to heat the raw material sands while the raw material sands fall into a vibration box (Japanese Patent Application Publication No. 2002-65815).

However, as for the method of sterilizing raw material sands by heating the raw material sands in a kiln while the raw material sands are fed by a conveyor, since the raw material sands are ultra fine sands, grains of the sand cohere to each other due to moisture or organic impurities, thereby forming a clod. For this reason, there has been a concern that the grains of sand in the clod are not sterilized even though heated.

As for the method of sterilizing raw material sands by supplying hot air to the raw material sands from below side to heat the raw material sand while the raw material sands fall into a vibration box, since hot air is supplied to the grains of sand, a clod of sands is less formed. However, unless the grains of sand are in contact with hot air for a sufficiently long time so as to be heated, there is a concern that the saprophytic bacteria remain. As a result, the bulk of the vibration box tends to be large.

### SUMMARY OF THE INVENTION

The present inventor developed an apparatus for sterilizing fine sands that supply raw material sands to a sterilization chamber having a closed cross-sectional shape, apply vertical vibration and forward feed vibration to the sterilization chamber so that the raw material sands are fed forward while jumping, throws burner flame to the raw material sands from above so that the raw material sands are heated to high temperature and attachments are separated from fine sand to sterilize the fine sands, thereby being capable of reliably sterilizing sands through the dispersion of sands without increasing bulk of the apparatus (PCT/JP2007/066748).

However, it has been proved that the fine sands sterilized in the above-mentioned apparatus for sterilizing fine sands have few things to worry about foreign substances or saprophytic bacteria but variation occurs in efficiency of water purification if the filter sands of the low speed filtrating method are used.

The present inventor has repeated various experiments about filter sands used in the low speed filtrating method, and have found out the following knowledge. That is, in some locations where raw material sands are collected, grains of fine sand have a sharp shape and foreign substances or saprophytic bacteria are attached thereto in the shape of mud.

It has been proved as follows: in the case of the above-mentioned muddy raw material sands, foreign substances or saprophytic bacteria may be removed by heating the raw material sands to high temperature. However, if the fine sands still have a sharp shape, gaps between the grains of the fine sand may have variation and capillarity is difficult to occur. For this reason, a variation of the function of the fine sands as a water purifying membrane occurs and causes a variation of the efficiency of purification.

An object of the present Invention is to provide an apparatus for sterilizing and smoothing fine sands that can reliably sterilize sands through the dispersion of sands without increasing bulk thereof, and can make the shape of sand become round to ensure high efficiency of purification in a low water-speed filtration.

An apparatus for sterilizing and smoothing fine sands according to the invention separates fine sands and attachments such as foreign substances and saprophytic bacteria from raw material sands, heats the fine sands to sterilize the fine sands, and makes sharp fine sands round by rubbing each other. The apparatus includes a feed chamber, a raw material sands feeding device, heating burners, and receiving means. The feed chamber includes an upstream receiving port and a downstream discharge port at both ends of a body that is composed of a floor and a cover and has a closed cross-sectional shape, receives the fine sands through the upstream receiving port, feeds the fine sands to the downstream discharge port by applying forward feed vibration to the floor while making the fine sands bounce by applying vertical vibration to the floor, and makes the raw material sands be rubbed against each other by the vertical vibration and forward feed vibration so that sharp portions of the fine sands become round. The raw material sands feeding device feeds the raw material sands to the upstream receiving port of the feed chamber in the shape of a curtain. The heating burners throw burner flame, of which the lateral width is substantially equal to that of the curtain-shaped raw material sands, into the feed chamber in a lateral direction, make the raw material sands be in contact with hot air having high temperature by making the burner flame cross the curtain-shaped raw material sands in order to separate dust of attachments from the fine sands, and heat the fine sands to sterilize the fine sands. The receiving means receives the sterilized fine sands, of which sharp portions are removed, from the downstream discharge port of the feed chamber.

In the above-mentioned apparatus for sterilizing fine sand (PCT/JP2007/066748), while vertical vibration and forward feed vibration are applied to raw material sands, burner flame was thrown to the raw material sands. Accordingly, attachments were not completely or sufficiently separated, and grains of fine sand were rubbed against each other in this state. As a result, it is thought that the fine sands still had a sharp shape.

According to an aspect of the invention, the raw material sands fall in the shape of a curtain and crosses the burner flame thrown in a lateral direction, and the attachments such as foreign substances or saprophytic bacteria of the raw material sands are quickly burnt and separated from the fine sands.

In this way, the attachments such as foreign substances or saprophytic bacteria are completely separated from the raw material sands, and the fine sands are fed by applying forward feed vibration thereto while bouncing by applying vertical vibration to the fine sands from which the attachments are removed. Accordingly, the grains of the fine sand are reliably rubbed against each other by the vertical vibration and forward feed vibration. As a result, the sharp portions of the fine sand are removed and the fine sand have a round shape that is optimum for water purification.

Further, the curtain-shaped raw material sands crosses the burner flame thrown in a lateral direction and the attachments such as foreign substances or saprophytic bacteria of the raw material sands are quickly burnt and separated from the fine sands. Therefore, it is possible to reliably sterilize and smooth the surface of fine sands.

Furthermore, since the raw material sands fall in the shape of a curtain and crosses the burner flame, it is possible to quickly and reliably heat the raw material sands to high temperature. In addition, since the bulk of the apparatus does not need to be significantly increased, it is possible to easily install the apparatus in a building having a common height.

If the blast volume of the burner is adjusted, it is possible to feed the fine sands on the floor in the feed chamber, and to separate dust from the fine sands in an inner space of the feed chamber and then send the dust to the downstream discharge port.

That is, the fine sands may be fed to the downstream discharge port on the floor in the feed chamber by the forward feed vibration, and the dust separated from the fine sand may be fed to the downstream discharge port through an inner space of the feed chamber by a force of the burner flame.

In this case, if a dust suction port for sucking the dust is formed at the downstream discharge port of the feed chamber and a suction duct and a dust collector are connected to the dust suction port, it is possible to efficiently collect and treat only dust without polluting the atmosphere. That is, it is preferable that a dust suction port for sucking the dust be formed at the downstream discharge port of the feed chamber and a suction duct be connected to the dust suction port so as to suck the dust.

The feed chamber may include a floor and a cover has a closed cross-sectional shape, and the material thereof is not particularly limited. However, considering that a high temperature atmosphere is formed in the chamber, at least inner walls thereof may be produced using a heat-resistant material, for example, a stainless steel plate and a heat-resistant resin. The reason why the feed chamber is formed to have a closed cross-sectional shape is to suppress the scattering of the dust, which is separated from the raw material sands, to the environment. The feed chamber can feed the fine sands by the forward feed vibration. However, if the feed chamber is inclined so that the front portion descends, it is possible to reliably feed the fine sands.

It is possible to quickly heat the raw material sands to high temperature by making the curtain-shaped raw material sands cross the burner flame. Accordingly, it is possible to expect that the clod of the raw material sand fragments into small pieces. However, it is preferable that the clod of the fine raw material sands fragment into small pieces before being fed to the feed chamber. Further, rock grains may be contained in the fine sands of the collected sea sands, river sands, and mountain sands.

The apparatus may further include a vibration feeder that receives unsterilized raw material sands and applies vertical vibration so as to make a clod of sand fragment into small pieces and feeds the small pieces to a raw material feeding device. The vibration feeder may include a mesh filter that filters rock grains.

If a large amount of fine sands are fed to the raw material feeding device at one time, it is not possible to feed the raw material sands to the feed chamber in the shape of a thin curtain having a constant thickness and there is a concern that variation may occur in the sterilization of the fine sands or in making the fine sands round.

The vibration feeder may be formed to feed a predetermined amount of fine sand. For example, a vibratory fixed quantity shooter may be provided in the vibration feeder, and the fixed quantity shooter may be formed in a planar shape to load a predetermined amount of fine sand thereon and to slowly feed the fine sands loaded on the fixed quantity shooter to the sterilization chamber.

The high temperature atmosphere formed in the chamber may correspond to temperature where the sterilized fine sands are not contaminated again, specifically, the temperature range of 150 to 300° C.

The sterilized and smoothed fine sands are used in the low water-speed filtration, the fine sands may have a mean diameter in the range of 0.08 to 1.8 mm.

It is preferable that the vibration feeder and the feed chamber vibrate in a vertical vibration and a forward direction. The vibration generating method may use an eccentric rotor, but it is preferable that the vibration generating method use electromagnetic vibration in consideration of the accurate vibration control. A known vibration mechanism may be used for the electromagnetic vibration. For example, it is preferable that the vibration generating method be a method of attracting a vibrating body against the spring force of a spring member by magnetism and returning the vibrating body by the spring force while the attraction is stopped.

### BRIEF DESCRIPTION OF THE DRAWINGS

FIG. 1 is a schematic view showing the configuration of an apparatus for sterilizing fine sand according to a preferred embodiment of the invention.

FIG. 2 is a plan view showing the configuration of the apparatus according to the embodiment.

FIG. 3 is a schematic perspective view showing the closed cross-sectional shape of a sterilization chamber of the embodiment.

FIG. 4 is a view showing the shapes of unsterilized raw material sand and sterilized fine sand in the embodiment.

10 Apparatus for sterilizing fine sand

11 Hopper

12 Vibration feeder

12A Shooter

13 Feed chamber

13A Upstream receiving port

13B Downstream discharge port

14 Heating burner

15 Shooter

17 Receiving container for sterilized fine sand

18 Water tank

### THE PREFERRED EMBODIMENTS OF THE INVENTION

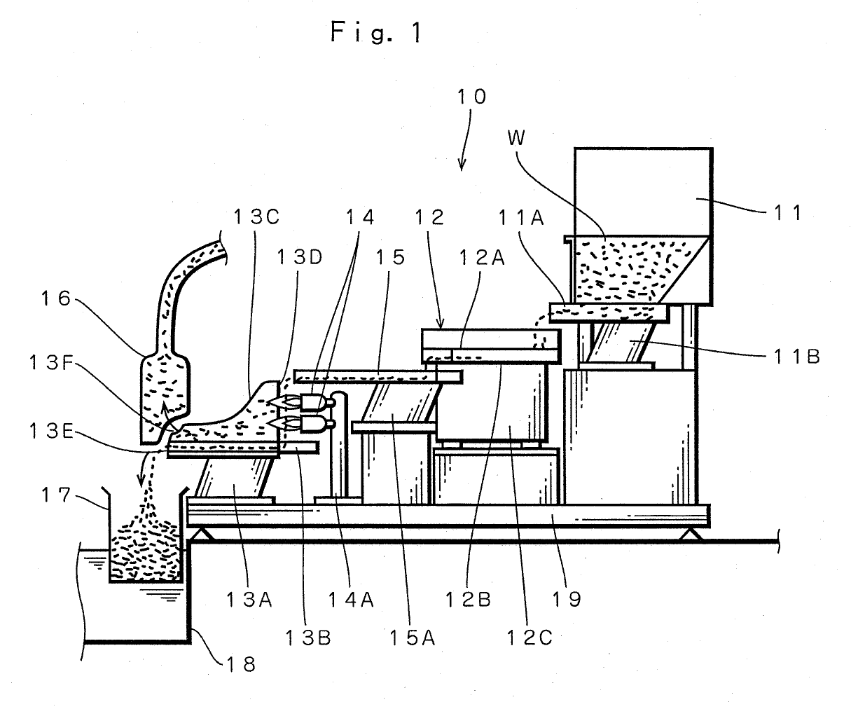

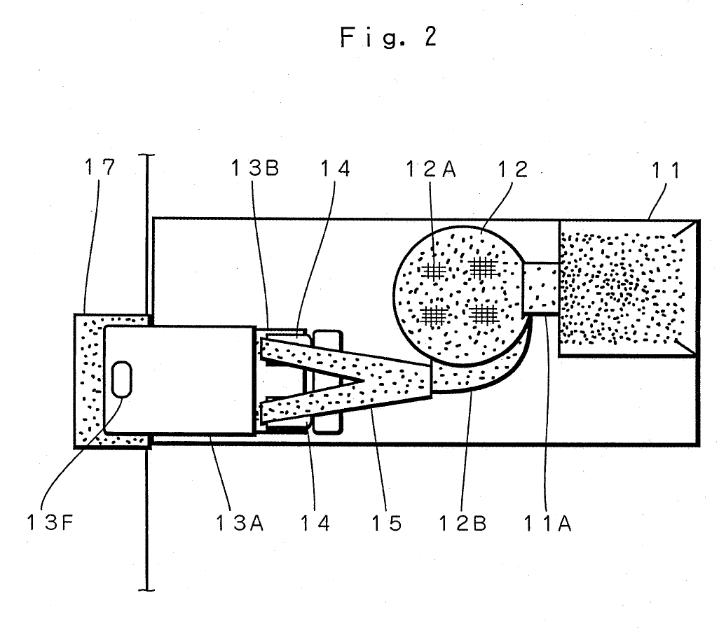

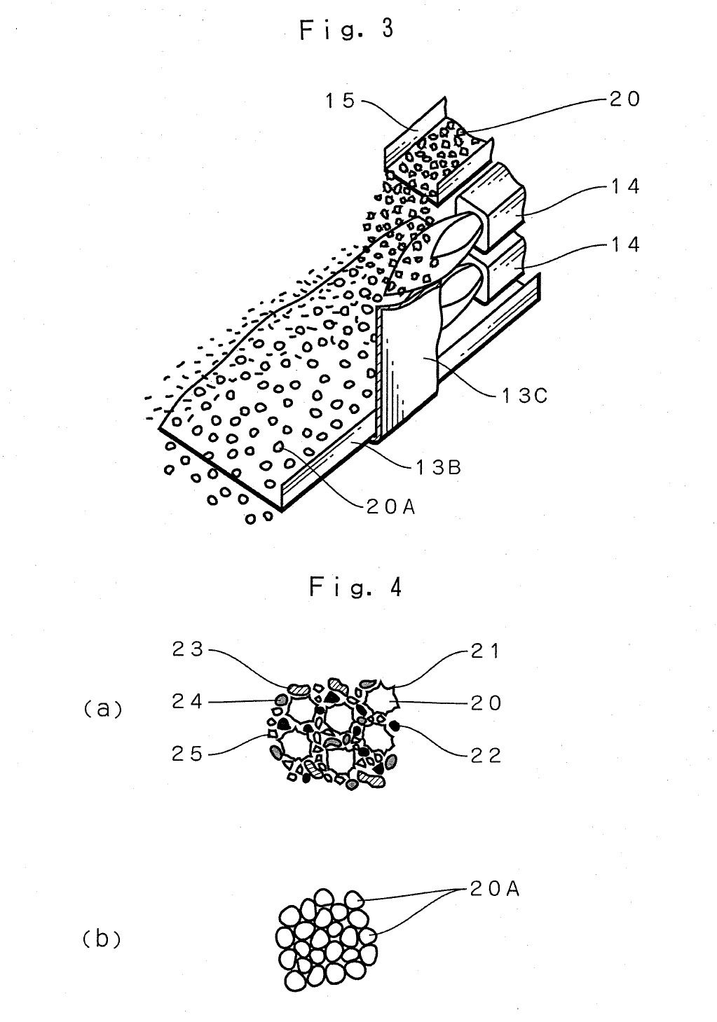

The invention will be described in detail below with reference to a specific embodiment shown in drawings. FIGS. 1 to 4 show an apparatus for sterilizing and smoothing fine sands according to a preferred embodiment of the invention. In the drawings, a hopper 11, which receives raw material sands W, such as collected sea sands, river sands, or mountain sands, are provided on a table 19 of a sterilizing apparatus 10. A discharge port is formed at the bottom of the hopper 11, and a feeder 11A is disposed below the discharge port. Further, a vibration generator 11B is provided below the hopper 11 to apply vertical vibration to the hopper 11 and the feeder 11A and to apply forward feed vibration to the feeder 11A.

A vibration feeder 12 is provided on the front side of the feeder 11A of the hopper 11. The vibration feeder 12 includes a tank of which the upper surface is opened, and a mesh filter 12A is stretched on the tank so that rock grains are separated from the raw material sands. A pan 12B for fine sands is provided on the lower side of the mesh filter 12A. The pan 12B receives forward feed vibration from a vibration generator 12C and measures the amount of the raw material sands so as to allow the feeder 11A to feed a predetermined amount of raw material sands.

A raw material feeding device 15 is provided on the lower side of the vibration feeder 12, and the raw material feeding device 15 includes a forked horizontal feeder. Raw material sand is load on the horizontal feeder with a constant thickness, is fed by the forward feed vibration applied by the vibration generator 15A, and falls in the shape of a curtain.

An upstream receiving port 13D of a feed chamber 13 is disposed on the front side of the raw material feeding device 15. For example, a cover 13C formed of a stainless steel plate covers a floor panel 13B formed of a stainless steel plate so as to form a closed cross-sectional shape, so that the feed chamber 13 is formed. An upstream receiving port 13D is formed on the upstream side of the feed chamber 13, and a downstream discharge port 13E is formed on the downstream side thereof. Further, a dust suction port 13F is formed on the downstream side of the cover 13B.

A vibration generator 13A is provided on the lower side of the feed chamber 13, and applies vertical vibration and forward feed vibration to the floor panel 13B of the feed chamber 13.

Further, a support 14A is mounted on the table 19 so as to stand up, and heating burners 14 are laterally mounted on the support 14A in the shape of a 2×2 matrix. Accordingly, the heating burners 14 throw burner flame, of which the lateral width is substantially equal to that of the curtain-shaped raw material sands, into the feed chamber 13 in a lateral direction.

A receiving container 17 for sterilized fine sand is disposed on the front side of the downstream discharge port 13E of the feed chamber 13, and the receiving container 17 is immersed in a cooling water tank 18. Further, a suction duct 16 is connected to the dust suction port 13F of the feed chamber 13 and the suction duct 16 is connected to a dust collector. Accordingly, the suction duct sucks dust in the feed chamber 13.

In this case, it is preferable that vertical vibration and forward feed vibration be vibration having, for example, a triangular waveform, an amplitude of 1 mm, and a frequency of 60 times/sec.

When sea sands, river sands, or mountain sands are collected, these raw material sands are input to the hopper 11. When the sterilization begins, the vibration generator 11B applies vertical vibration to the hopper 11, the raw material sands of the hopper 11 falls onto the feeder 11A little by little, the vibration generator 11B applies forward feed vibration to the feeder 11A, and the raw material sands on the feeder 11A falls onto the vibration feeder 12 little by little.

In the vibration feeder 12, the mesh filter 12A is adjusted to have an aperture of, for example, 1.8 mm and the vibration feeder 12 vibrates in a vertical direction so that the raw material sands fall onto the mesh filter 12A. If the raw material sands fall, sands having a size of 1.8 mm or more are sorted. Sand grains or rock grains having a size of 1.8 mm or more are filtered by the mesh filter 12A.

The pan 12B applies vertical vibration to the sorted fine sands having a size of 1.8 mm or less so as to disperse the sorted fine sands, and measures the amount of the sorted fine sands so as to allow the feeder 12A to feed a predetermined amount thereof to the raw material feeding device 15.

The vibration generator 15A applies forward feed vibration to the sands in the raw material feeding device 15. The fine raw material sands are spread on the entire surface of the forked horizontal feeder with a uniform thickness, and falls onto the upstream receiving port 13D of the feed chamber 13 in the shape of a curtain that has a predetermined width in a lateral direction.

In this case, the heating burners 14 throw burner flame, of which the temperature is high, for example, in the range of 150 to 300° C., in a lateral direction. The curtain-shaped raw material sands are in contact with the burner flame while crossing the burner flame, so that the raw material sands are quickly heated to high temperature. Accordingly, attachments, such as foreign substances of saprophytic bacteria of the raw material sands are burned and become dust, and are then sent into the feed chamber 13. Then, the fine sands sterilized through the separation of the attachments are loaded from the upstream receiving port 13D onto the floor 13B of the feed chamber 13.

The vibration generator 13A applies vertical vibration and forward feed vibration to the floor 13B of the feed chamber 13. Accordingly, while bouncing from the bottom 13B due to the vertical vibration, grains of the fine sand loaded onto the floor 13B of the feed chamber 13 are fed to the downstream discharge port 13B. As a result, the grains of the fine sand are rubbed against each other so that sharp portions of each grain of the fine sand become round.

Since dust contained in the fine sands are sucked by the suction duct 16, the sterilized and rounded fine sands having a mean diameter in the range of 0.08 to 1.8 mm are received in the receiving container 17 and then cooled.

When applied to low water-speed filtration, the fine sands are sorted into first fine sands having a mean diameter in the range of 0.08 to 0.3 mm and second fine sands having a mean diameter in the range of 0.4 to 1.8 mm and may be used for upper and lower filter sand tanks.

When the present inventor observed unsterilized raw material sands and sterilized fine sands by a microscope, it was confirmed that the raw material sands have sharp portions in the grains of the fine sand 20, and saprophytic bacteria 21, dust 22, dirt 23, foreign substances 24, and mud 25 existed between the grains of the fine sand 20 as shown in FIG. 4A. In contrast, when the present inventor observed sterilized fine sands 20′, it was confirmed as follows: sharp portions of each grain of fine sand were removed and became round, saprophytic bacteria 21 were not shown between the grains of the fine sand 20′ as shown in FIG. 4B, and the sterilized fine sand was optimum for filter sand of low water-speed filtration.

### INDUSTRIAL APPLICABILITY

According to the invention, it is possible to reliably sterilize raw material sands collected from a river or a mountain and to make the shape of sand be optimum. Therefore, since being capable of being used as filter sand for purifying drinking water, the sterilized sands are very useful.

What is claimed is:

1. An apparatus for sterilizing and smoothing fine sands that separates fine sands and attachments such as foreign substances and saprophytic bacteria from raw material sands, heats the fine sands to sterilize the fine sands, and makes sharp fine sand round, the apparatus comprising:
a feed chamber 13 of which a body includes a floor 13B and a cover 13C and has a closed cross-sectional shape, the feed chamber including an upstream receiving port 13D and a downstream discharge port 13E at both ends of the body, receiving the raw material sands 20 through the upstream receiving port 13D, feeding the raw material sands to the downstream discharge port 13B while making the raw material sands 20 bounce by applying vertical vibration and forward feed vibration to the floor 13B, and making the raw material sands 20 be rubbed against each other by the vertical vibration and forward feed vibration so that sharp portions 21 of the fine sand become round;
a raw material sand feeding device 15 that feeds the raw material sands 20 to the upstream receiving port 13D of the feed chamber 13 in the shape of a curtain;
heating burners 14 that throw burner flame, of which the lateral width is substantially equal to that of the curtain-shaped raw material sands 20, into the feed chamber 13 in a lateral direction, make the raw material sands be in contact with hot air having high temperature by making the burner flame cross the curtain-shaped raw material sands 20 in order to separate dust of attachments 22, 23, 24, and 25 from the fine sand 20A, and heat the fine sands to sterilize the fine sands; and
receiving means 17 that receives the sterilized fine sand 20A, of which sharp portions are removed, from the downstream discharge port 13E of the feed chamber 13.

2. The apparatus according to claim 1, wherein the fine sands 20A are fed to the downstream discharge port 13E on the floor 13B in the feed chamber 13 by the forward feed vibration, and
the dusts separated from the fine sand 20A are fed to the downstream discharge port 13E through an inner space of the feed chamber 13 by a force of the burner flame.

3. The apparatus according to claim 1, wherein a dust suction port 13F for sucking the dusts is formed at the downstream discharge port 13E of the feed chamber 13, and a suction duct 16 is connected to the dust suction port 13F so as to suck the dust.

4. The apparatus according to claim 1, further comprising:
a hopper 11 that temporarily stores raw material sands; and
a vibration feeder 12 that receives the raw material sands W from the hopper 11, applies vertical vibration so as to disperse the raw material sands W, and measures the amount of the raw material sands W so as to feed a predetermined amount of raw material sands to a raw material feeding device 15.

5. The apparatus according to claim 4, wherein the vibration feeder 12 includes a mesh filter 12A that filters rock grains contained in the raw material sands.
